(19) United States
(12) Patent Application Publication
(10) Pub. No.: US 2026/0087403 A1
(43) Pub. Date: Mar. 26, 2026

(54) SYSTEM AND METHOD FOR DETERMINATION OF QUALITY LABEL FOR PROBE DATA

(71) Applicant: HERE Global B.V., Eindhoven (NL)

(72) Inventors: Chandra PATI, East Godavari (IN); Atiquer SAYYED, Vapi (IN); Ashish PANCHAL, West Mumbai (IN)

(21) Appl. No.: 18/896,361

(22) Filed: Sep. 25, 2024

(51) Int. Cl. G06N 20/00

(52) U.S. Cl. CPC G06N 20/00

(57) ABSTRACT

A system for determination of quality label for probe data is disclosed. The system obtains probe data associated with a road segment. The probe data includes a set of probe data records. The system further applies a machine learning (ML) model on the set of probe data records to determine an anomaly score for each probe data record of the set of probe data records. The ML model is trained to detect a set of anomalies associated with the probe data and further assign an anomaly score to each probe data record of the set of probe data records based on the detected set of anomalies. The system further determines a quality label for the probe data based on the anomaly score.

### TECHNOLOGICAL FIELD

The present disclosure generally relates to probe data, and more particularly relates to a system and a method for determination of quality label for probe data.

### BACKGROUND

In mapping systems, probe data (also referred to as map probe data) plays a crucial role in providing accurate and up-to-date information to users, facilitating efficient route planning, navigation, and location-based services. The probe data typically includes traces of Global navigation satellite system (GNSS) such as global positions services (GPS) traces, sensor data, and other relevant information collected from a variety of data sources, including vehicles equipped with navigation systems, mobile devices, and specialized mapping vehicles. Such data sources often differ in terms of accuracy, coverage, and granularity, leading to challenges in integrating and interpreting heterogeneous data sets for use in a variety of applications such as navigation applications. However, the quality of map probe data can vary significantly depending on factors such as the data source, collection methods, and inherent errors introduced during data transmission or processing.

One of the primary challenges in leveraging the probe data is assessing its quality and reliability. The probe data may contain errors, inaccuracies, or inconsistencies due to factors such as signal noise, GPS drift, multipath effects, sensor malfunctions, and environmental conditions. Moreover, the probe data received from different vendors may exhibit varying levels of quality and may require different processing techniques to correct or mitigate errors. The usage of such probe data may lead to undesirable results in the map services. Such undesirable results incur financial as well as reputational losses to the service provider.

Existing methods for assessing probe data quality often rely on map-matching techniques which involve matching GPS data to the correct paths on a map and measuring the differences or deviations of the probe data from the correct paths. However, the accuracy of these metrics depends on the accuracy of reference map at the given location.

Therefore, there exists a need for improved techniques to determine the quality of probe data received from different vendors, considering the inherent errors and uncertainties associated with the data.

### BRIEF SUMMARY OF SOME EXAMPLE EMBODIMENTS

A system, a method, and a computer programmable product are provided for implementing the process for determination of quality label for probe data.

In one aspect, a method for training a machine learning model is disclosed. The method includes receiving probe data and ground truth data associated with the probe data. The probe data includes a set of probe data records. The method further includes detecting a set of anomalies associated with the probe data based on an association of the probe data with the ground truth data. The method further includes assigning an anomaly score to each probe data record of the set of probe data records based upon the detected set of anomalies. The anomaly score is indicative of a degree of deviation of corresponding probe data record from the ground truth data. The method further includes generating a training dataset based on the probe data, the detected set of anomalies, and the assigned anomaly score. The method further includes training a machine learning (ML) model based on the training dataset for detection of anomalies and generation of a probe data quality score.

In additional method embodiments, the detected set of anomalies includes at least one of an invalid probe, a distant probe, a parking probe, a spiked value probe, and a zero-speed value probe.

In additional method embodiments, the method includes identifying one or more probe data records with missing speed and heading data. The missing speed and heading data are further used to assign the anomaly score.

In additional method embodiments, the method further includes detecting the set of anomalies based on an application of at least one of a map matching technique or a filtering technique on the set of probe data records and the ground truth data.

In additional method embodiments, the filtering technique corresponds to a Kalman filtering technique.

In additional method embodiments, the method further includes assigning the anomaly score based on a predefined weight assigned to each of the detected set of anomalies.

In additional method embodiments, the method includes assigning the anomaly score based on a predefined weight assigned to each of the detected anomalies.

In additional method embodiments, the method includes assigning the predefined weight based on a functional class and a region type of a road segment associated with the probe data.

In additional method embodiments, the method includes generating artificial training data based on the probe data, the set of anomalies and the anomaly score. The method further included training the machine learning (ML) model based on the artificial training dataset for the detection of anomalies and generation of the probe data quality score.

In additional method embodiments, the ML model is categorized as a sequence-to-sequence-based ML model. The ML model corresponds to an attention-based encoder-decoder ML model.

In another aspect, a system for determination of quality label for probe data is disclosed. The system includes at least one processor and at least one non-transitory memory including computer program code instructions, the computer program code instructions configured to, when executed, cause the apparatus to obtain probe data associated with a road segment. The probe data includes a set of probe data records. The computer program code instructions are configured to, when executed, cause the system to apply a machine learning (ML) model on the set of the probe data to determine anomaly score for each of the set of probe data. The ML model is trained to detect a set of anomalies associated with the probe data and further assign an anomaly score to each probe data record of the set of probe data records based on the detected set of anomalies. The computer program code instructions are configured to, when executed, cause the system to determine a quality label for the probe data based on the anomaly score.

In additional system embodiments, the detected set of anomalies includes at least one of an invalid probe, a distant probe, a parking probe, a spiked value probe, and a zero-speed value probe.

In additional system embodiments, the anomaly score is assigned based on a predefined weight assigned to each of the detected set of anomalies.

In additional system embodiments, the predefined weight is assigned based on a functional class and a region type of a road segment associated with the probe data.

In additional system embodiments, the system is caused to perform identify one or more probe data records with missing speed and heading data, wherein the missing speed and heading data is further used to assign the anomaly score.

In additional system embodiments, the ML model is categorized as a sequence-to-sequence-based ML model. The ML model corresponds to an attention-based encoder-decoder ML model.

In yet another aspect, a non-transitory computer-readable medium having stored thereon computer-executable instructions that when executed by a processor of a system, causes the processor to execute operations for determination of quality label for probe data is disclosed. The operations include obtaining probe data associated with a road segment. The probe data includes a set of probe data records. The operations further include applying a machine learning (ML) model on the set of probe data records to determine an anomaly score for each probe data record of the set of probe data records. The ML model is trained to detect a set of anomalies associated with the probe data and further assign an anomaly score to each probe data record of the set of probe data records based on the detected set of anomalies. The operations further include determining a quality label for the probe data based on the anomaly score.

In additional computer-readable medium embodiments, the detected set of anomalies includes at least one of an invalid probe, a distant probe, a parking probe, a spiked value probe, and a zero-speed value probe.

In additional computer-readable medium embodiments, the operations include identifying one or more probe data records with missing speed and heading data, wherein the missing speed and heading data is further used to assign the anomaly score.

In additional computer-readable medium embodiments, the anomaly score is assigned based on a predefined weight assigned to each of the detected set of anomalies.

In additional computer-readable medium embodiments, the predefined weight is assigned based on a functional class and a region type of a road segment associated with the probe data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1A is a diagram that illustrates a network environment for determination of quality label for probe data, in accordance with an embodiment of the disclosure;

FIG. 1B is a diagram that illustrates distant probes, in accordance with an embodiment of the disclosure;

FIG. 1C is a diagram that illustrates parking probes, in accordance with an embodiment of the disclosure;

FIG. 1D is a diagram that illustrates spiked value probes, in accordance with an embodiment of the disclosure;

FIG. 1E is a diagram that illustrates zero-speed value probes, in accordance with an embodiment of the disclosure;

FIG. 2 illustrates a block diagram of the system of FIG. 1A, in accordance with an embodiment of the disclosure;

FIG. 3A is a block diagram that illustrates exemplary operations for training of machine learning model for determination of quality label for probe data, in accordance with an embodiment of the disclosure;

FIG. 3B is a block diagram that illustrates training of the ML model for the detection of the set of anomalies and generation of the probe data quality score, in accordance with an embodiment of the disclosure;

FIG. 4 is a block diagram that illustrates exemplary operations for determination of quality label for probe data, in accordance with an embodiment of the disclosure;

FIG. 5 is a block diagram that depicts operations for the assignment of set of anomalies to the set of probe data records of the probe data, in accordance with an embodiment of the disclosure;

FIG. 6 is a block diagram that illustrates training of the ML model and determination of the quality label for the probe data using the trained ML model, in accordance with an embodiment of the disclosure;

FIG. 7 is a flowchart that illustrates an exemplary method for training of ML model for determination of quality label for probe data, in accordance with an embodiment of the disclosure; and

FIG. 8 is a flowchart that illustrates an exemplary method for determination of quality label for the probe data, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received, and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the description and should not be regarded as limiting. Any heading utilized within this description is for convenience only and has no legal or limiting effect.

The present disclosure may provide a system, a method, and a computer programmable product for the determination of quality label for probe data. The disclosed system and the method provide techniques for the training of a machine learning model for detection of a set of anomalies associated with a set of probe data records and further generation of the probe data quality score associated with the probe data. Usually, mapping service providers (or navigation service providers) acquire massive amounts of probe data from multiple vendors. Such probe data is used to provide various mapping-based services (such as route planning, traffic management, and location-based services) to an end-user. Traditionally, a few quality checks are applied to the received probe data to determine the quality of the probe data and to further determine whether the probe data should be used for improving the mapping-based services provided by the mapping service providers. Traditionally probe data quality score estimation systems often rely on map-matching techniques which involve matching GPS data to the correct paths on a map and measuring the differences. However, the accuracy of these metrics depends on the accuracy of reference map at the given location. Moreover, traditional probe data quality score estimation systems lack robust frameworks to find proper quality metrics calculated on probe data from specific vendors. The absence of comprehensive quality metrics at the level of individual drives or sessions poses challenges in effective management and use of probe data for various products or services.

The disclosed system may estimate probe data quality by applying the trained ML model on the probe data to identify the inconsistent, invalid, and undesired probe points from the probe data. The ML model is pre-trained on a historical dataset to identify the inconsistent, invalid, and undesired probe points and output a probe quality score that may be used to as an indicator of the probe data.

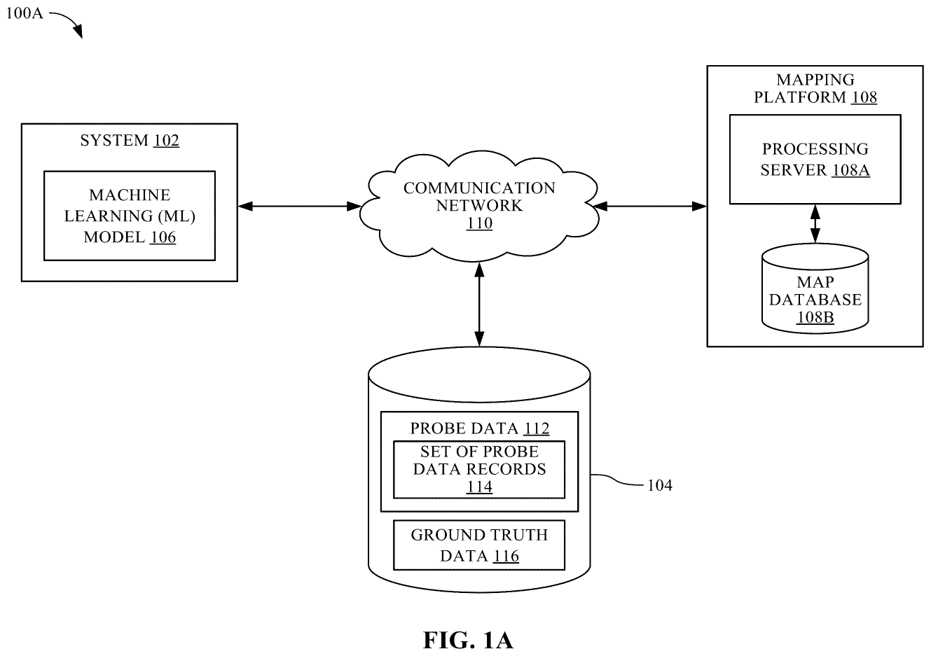

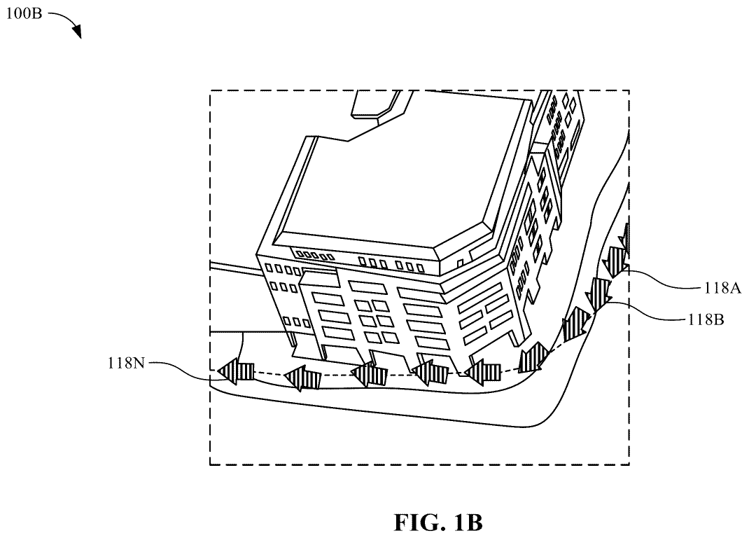

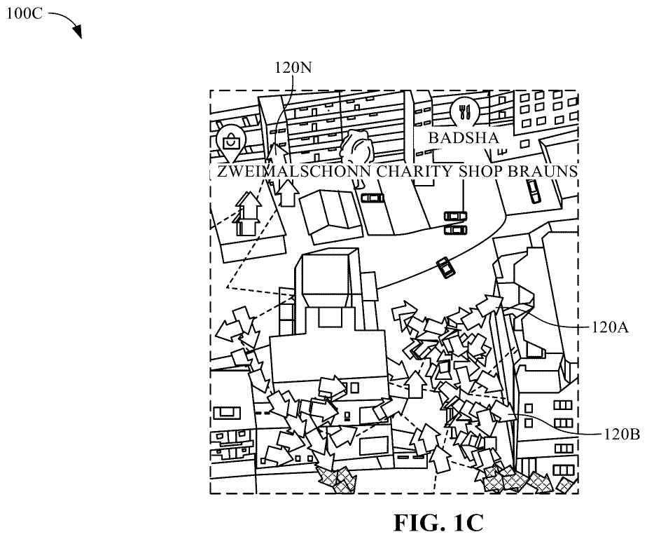

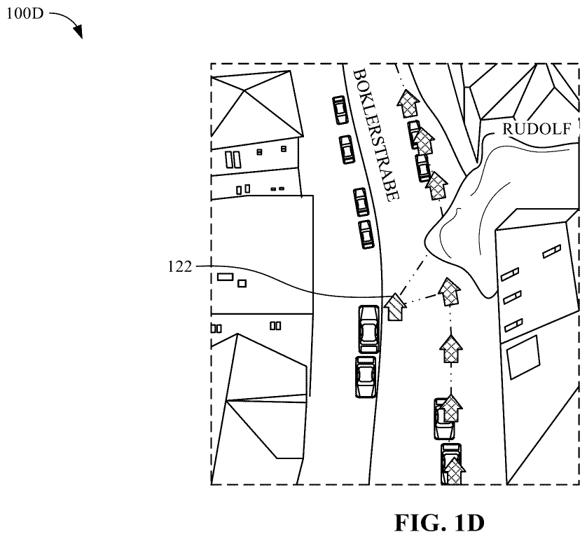

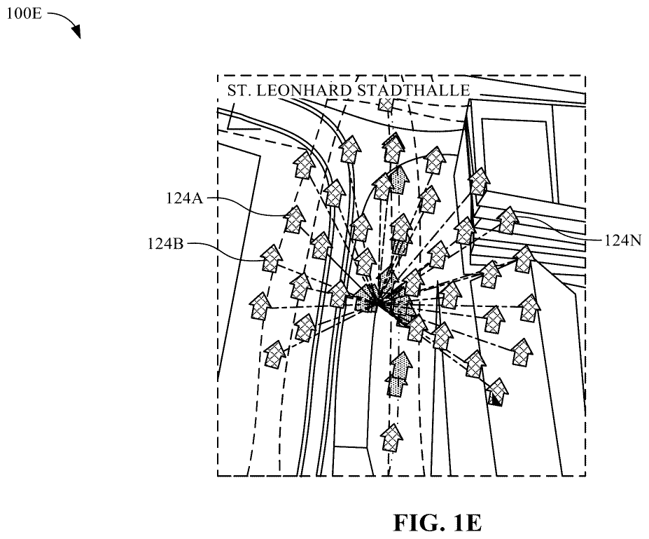

FIG. 1A is a diagram that illustrates a network environment 100A for determination of quality label for probe data, in accordance with an embodiment of the disclosure. With reference to FIG. 1A, there is shown a diagram of the network environment 100A. The network environment 100A includes a system 102, one or more data sources 104, a machine learning (ML) model 106, and a mapping platform 108. The mapping platform 108 may include a processing server 108A and a map database 108B. The network environment 100A may further include a communication network 110. With reference to FIG. 1A, there is further shown probe data 112 that may include a set of probe data records 114. In an embodiment, the ML model 106 may be integrated within the system 102.

The probe data 112 may contain errors, inaccuracies, or inconsistencies due to factors such as signal noise, GPS drift, multipath effects, sensor malfunctions, and environmental conditions. It may be desired to detect such errors, inaccuracies, or inconsistencies (collectively referred to as anomalies) that may be present in the probe data 112. To detect such anomalies that may be present in the probe data 112, the system 102 may be configured to train the ML model 106.

In operation, the system 102 may be configured to receive the probe data 112 that may include the set of probe data records 114. The probe data 112 may be received from the one or more data sources 104. Each probe data record of the set of probe data records may include information about various parameters that may be captured by a vehicle at a particular point in time. In an embodiment, each probe data record of the set of probe data records may include at least one of location information associated with a corresponding probe point, timestamp information associated with capturing of the corresponding probe point, speed information associated with the capturing of the corresponding probe point, and heading information associated with the capturing of the corresponding probe point. In an embodiment, the location information associated with the probe point may be indicative of a functional class of the road segment on which the vehicle may be traveling, a location of the vehicle, and a country code (or a region type) indicative of a country in which the vehicle may be traveling.

The system 102 may be further configured to receive the ground truth data 116 from at least one of the map database 108B or the one or more data sources 104. The system 102 may be further configured to detect a set of anomalies that may be associated with the probe data 112. The set of anomalies may be detected based on an association of the probe data 112 and the ground truth data 116. The detected set of anomalies may include at least one of an invalid probe, a distant probe, a parking probe, a spiked value probe, and a zero-speed value probe. In an embodiment, the detected set of anomalies may include may also include a missing speed or heading value probe.

The invalid probe may correspond to the probe points collected by the vehicle that may be unusable due to errors or inconsistencies. Such errors may arise from various issues such as corrupted data, sensor malfunctions, or communication errors. The distant probes (also known as Probes away from the road) may correspond to the probe points collected by the vehicle that indicate the location of the vehicle as being off the designated road network (such as on pavements, or in buildings). The distant probes 118A, 118B, through 118N are shown in diagram 100B, as illustrated in FIG. 1B. The parking probes may correspond to the probe points that may indicate a vehicle is stationary and parked and may be characterized by an extremely low or zero speed over a significant duration. The parking probes 120A, 120B, through 120N are illustrated in diagram 100C, as shown in FIG. 1C. The spiked value probe may refer to sudden, significant changes in the speed or location of the vehicle that is not consistent with a normal vehicle movement. Such an anomaly may be caused by GPS errors, data transmission glitches, or rapid acceleration/deceleration by the vehicle collecting the probe data 112. The spiked probe 122 is shown in diagram 100D, as illustrated in FIG. 1D. The zero-speed value probe may correspond to the probe points that indicate the vehicle is at a complete stop. The zero-speed value probes 124A, 124B, through 124N are illustrated in diagram 100E, as shown in FIG. 1E. The missing speed or heading probes may correspond to the data points where the information associated with the speed, or the direction of the vehicle may be absent.

The system 102 may be further configured to assign an anomaly score to each probe data record of the set of probe data records based upon the detected set of anomalies. The anomaly score may be indicative of a degree of deviation of corresponding probe data record from the ground truth data. The system 102 may be further configured to generate a training dataset based on the probe data, the detected set of anomalies, and the assigned anomaly score. The system 102 may further train the ML model 106 based on the training dataset for the detection of the set of anomalies and generation of a probe data quality score.

Once the ML model 106 is trained, the system 102 may be further configured to obtain the probe data 112 associated with the road segment. The probe data 112 may include the set of probe data records 114. The system 102 may be further configured to apply the ML model 106 on the set of probe data records to determine an anomaly score for each probe data record of the set of probe data records. The ML model 106 may be trained to a set of anomalies associated with the probe data and further assign an anomaly score to each probe data record of the set of probe data records based on the detected set of anomalies. The system 102 may be further configured to determine a quality label for the probe data based on the anomaly score.

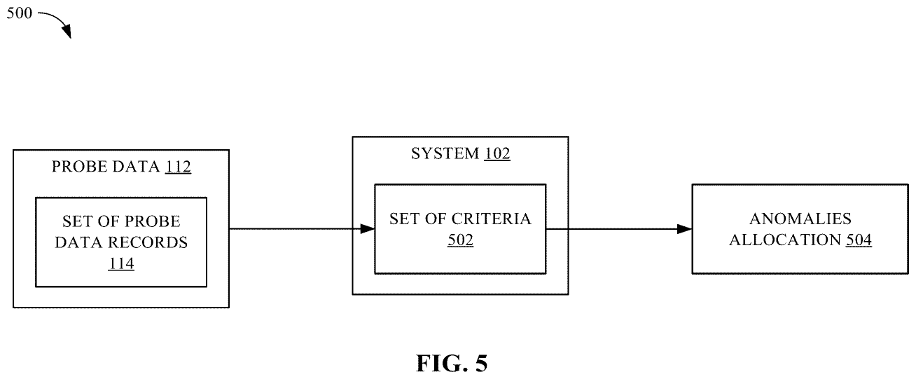

FIG. 1B is a diagram that illustrates distant probes, in accordance with an embodiment of the disclosure. FIG. 1B is explained in conjunction with FIG. 1A. In FIG. 1B, there is shown the diagram 100B that illustrates the distant probes 118A, 118B, through 118N. As discussed above and as shown in FIG. 1B, the distant probes 118A, 118B, through 118N (also known as Probes away from the road) may correspond to the probe points collected by the vehicle that indicate the location of the vehicle as being off the designated road network (such as on pavements, or in buildings). Specifically, the probes that may be detected as being away from the road refer to sensors or devices that have registered a location or status indicating that they are no longer within the boundaries of a designated road or path. This could be due to various reasons such as deviations from the expected route, potential off-road driving, or errors in positioning data. In an embodiment, the system 102 may be configured to detect the distant probes 118A, 118B, through 118N from the probe data 112. Details about the detection of the distant probes 118A, 118B, through 118N from the probe data 112 are provided, for example, in FIG. 5.

FIG. 1C is a diagram that illustrates parking probes, in accordance with an embodiment of the disclosure. FIG. 1C is explained in conjunction with FIG. 1A and FIG. 1B. In FIG. 1C, there is shown the diagram 100C that illustrates the parking probes 120A, 120B, through 120N. As discussed above and as shown in FIG. 1C, the parking probes 120A, 120B, through 120N may correspond to the probe points that may indicate a vehicle is stationary and parked and may be characterized by an extremely low or zero speed over a significant duration. Specifically, the parking probes 120A, 120B, through 120N may refer to data points that capture information related to parking events, such as the location where a vehicle may be parked, or the transition from movement to a stationary state, or the duration of the parking. In an embodiment, the system 102 may be configured to detect the parking probes 120A, 120B, through 120N from the probe data 112. Details about the detection of the parking probes 120A, 120B, through 120N from the probe data 112 are provided, for example, in FIG. 5.

FIG. 1D is a diagram that illustrates spiked value probes, in accordance with an embodiment of the disclosure. FIG. 1D is explained in conjunction with FIG. 1A. FIG. 1B, and FIG. 1C. In FIG. 1D, there is shown the diagram 100D that illustrates the spiked probe 122. As discussed above and as shown in FIG. 1D, the spiked probe 122 may refer to sudden, significant changes in the speed or location of the vehicle that is not consistent with a normal vehicle movement. Such an anomaly may be caused by GPS errors, data transmission glitches, or rapid acceleration/deceleration by the vehicle collecting the probe data 112. In an embodiment, the system 102 may be configured to detect the spiked probe 122 from the probe data 112. Details about the detection of the spiked probe 122 from the probe data 112 are provided, for example, in FIG. 5.

FIG. 1E is a diagram that illustrates zero-speed value probes, in accordance with an embodiment of the disclosure. FIG. 1E is explained in conjunction with FIG. 1A. FIG. 1B, FIG. 1C, and FIG. 1D. In FIG. 1E, there is shown the diagram 100E that illustrates the zero-speed value probes 124A, 124B, through 124N. As discussed above and as shown in FIG. 1E, the zero-speed value probes 124A, 124B, through 124N may correspond to the probe points that indicate the vehicle is at a complete stop. In an embodiment, the system 102 may be configured to detect the zero-speed value probes 124A, 124B, through 124N from the probe data 112. Details about the detection of the zero-speed value probes 124A, 124B, through 124N from the probe data 112 are provided, for example, in FIG. 5.

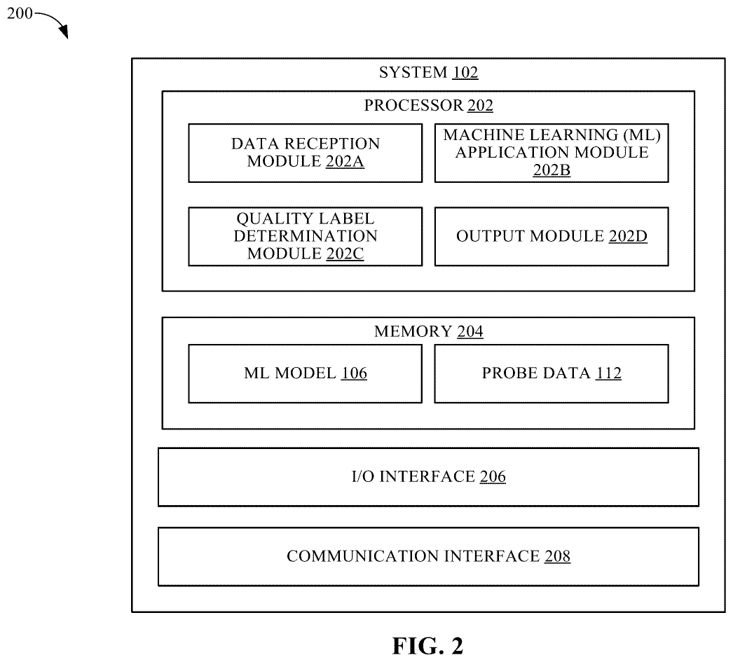

FIG. 2 illustrates a block diagram 200 of the system of FIG. 1A, in accordance with an embodiment of the disclosure. FIG. 2 is explained in conjunction with FIG. 1A, FIG. 1B, FIG. 1C, FIG. 1D, and FIG. 1E. In FIG. 2, there is shown the block diagram 200 of the system 102. The system 102 may include at least one processor 202 (referred to as a processor 202, hereinafter), at least one non-transitory memory 204 (referred to as a memory 204, hereinafter), an input/output (I/O) interface 206, and a communication interface 208. The processor 202 may comprise modules, depicted as, a probe data reception module 202A, an ML model application module 202B, a quality label determination module 202C, and an output module 202D. The processor 202 may be connected to the memory 204, and the I/O interface 206 through wired or wireless connections. Although in FIG. 2, it is shown that the system 102 includes the processor 202, the memory 204, and the I/O interface 206 however, the disclosure may not be so limiting and the system 102 may include fewer or more components to perform the same or other functions of the system 102. In an embodiment, the probe data reception module 202A, and the output module 202D may be integrated within the I/O interface 206. In some embodiments, the probe data reception module 202A may receive the probe data 112 from the one or more data sources 104 and the output module 202D may output processed data (such as the probe data quality score) via the I/O interface 206.

In accordance with an embodiment, the system 102 may store data that may be generated by the modules while performing corresponding operations or may be retrieved from a database associated with the system 102, such as the map database 108B, in the memory 204. For example, the data may include vehicle information, traffic information, user information, distance information, and environmental information.

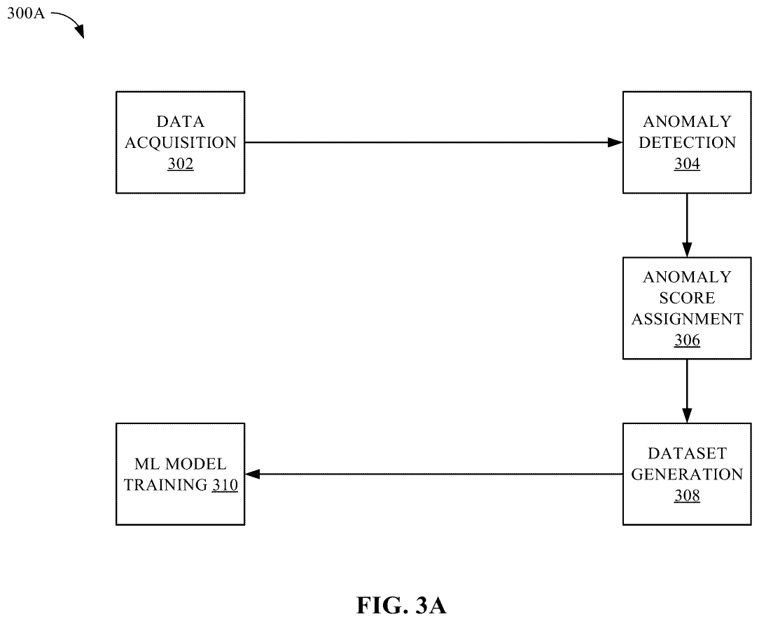

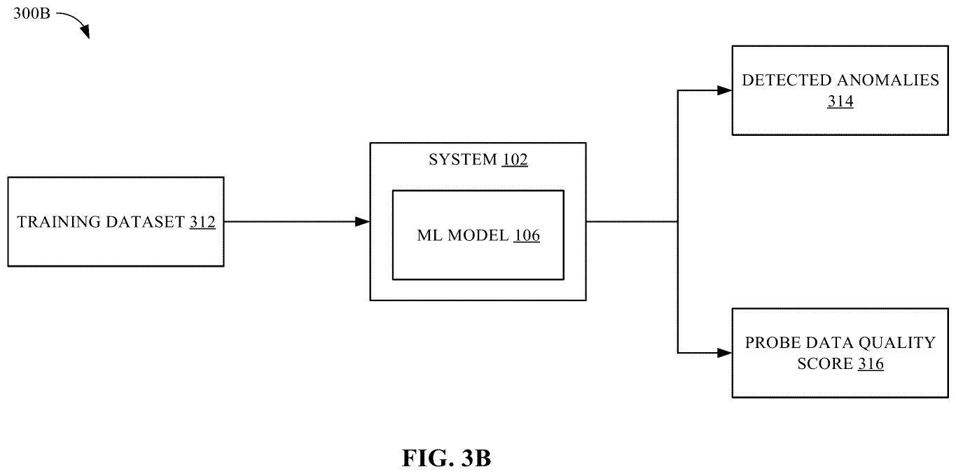

FIG. 3A is a block diagram 300A that illustrates exemplary operations for training of machine learning model for determination of quality label for probe data, in accordance with an embodiment of the disclosure. FIG. 3A is explained in conjunction with elements from FIG. 1A and FIG. 2. With reference to FIG. 3A, there is shown the block diagram 300A that illustrates exemplary operations from 302 to 310, as described herein. The exemplary operations illustrated in the block diagram 300 may start at 302 and may be performed by any computing system, apparatus, or device, such as by the system 102 of FIG. 1A or the processor 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302, a data acquisition operation may be executed. In the data acquisition operation, the system 102 may be configured to receive the probe data 112 and ground truth data 116. Specifically, the data reception module 202A of the processor 202 may be configured to receive the probe data 112 and the ground truth data 116 associated with a road segment.

In an embodiment, the probe data 112 associated with the road segment may be received from the one or more data sources 104 via the communication network 110. Each of the one or more data sources 104 may correspond to databases or repositories associated with the one or more vendors of the probe data 112. The probe data 112 (or the floating car data (FCD)) may be captured by one or more vehicles that may be travelling on the road segment. Specifically, the probe data 112 may be captured by GNSS or GPS systems installed within one or more vehicles. In an embodiment, a position of each vehicle of the one or more vehicles may be established using this satellite-based positioning system.

The probe data 112 may include the set of probe data records 114. Each probe data record of the set of probe data records 114 may be associated with a probe point at which parameters of the probe data record may be captured. Each probe data record may include at least one of location information associated with the corresponding probe point, timestamp information associated with capturing the corresponding probe point, speed information associated with the capturing of the corresponding probe point, and heading information associated with the capturing of the corresponding probe point.

In an embodiment, the location information associated with the corresponding probe point may indicate a functional class of the road segment on which the corresponding probe data record was captured by the one or more vehicles, a location at which the corresponding probe data record was captured, and a country code (or a region type) indicative of a country of the road segment where the corresponding probe point was captured. The timestamp information may include a timestamp when the corresponding probe data was recorded. The speed information may include the speed of the vehicle when the corresponding probe point was captured by the vehicle. The heading information may include a direction in which the vehicle was moving when the corresponding probe point was captured by the vehicle.

The functional class of the road segment associated with the probe point may be indicative of the functional class of the road segment where the probe point was captured by the one or more vehicles. The functional class (or the class feature) may be a road type indicator that may reflect a traffic speed and a traffic volume, as well as the importance and connectivity of the road segment. The functional class of the road segment may be a numerical value ranging from 1 to 5. For example, the functional class “1” may indicate a road with a high-volume traffic, and a maximum-speed traffic. The functional class “2” may indicate a road with a high volume, and a high-speed traffic. The functional class “3” may indicate a road with a high-volume traffic. The functional class “4” may indicate a road with a high-volume traffic at moderate speeds between neighborhoods and the functional class “5” may indicate a road whose volume and traffic flow may be below the level of any other functional class.

The location associated with the corresponding probe point may correspond to a geographic coordinates of the location where the probe point was captured by the one or more vehicles. Specifically, the location associated with the corresponding probe point may include a latitude value and a longitude value of the geographic coordinates. The country code (or the region type) may be indicative of the country of the road segment associated with where the probe point was captured. In an embodiment, the country code may be indicative of a type of region (or region type) that may be associated with the road segment. An example of the probe data 112 with 2 probe data records is shown in Table 1 below.

TABLE 1
Probe Data

| S. | Data | Functional | | | | | Country | |
|---|---|---|---|---|---|---|---|---|
| No. | Source | Class | Longitude | Latitude | Speed | Heading | Code | Timestamp |
| 1 | ABCD | 1 | 45.5652 | 89.7874 | 40 | 4.0 | ARG | 20240315 |
| | | | | | | | | 10:45:27 |
| 2 | DEF | 1 | 23.5433 | 109.332 | 56 | 6.0 | GER | 20230417 |
| | | | | | | | | 17:23:43 |

In an embodiment, the ground truth data 116 may refer to an accurate, real-world data that may be used as a reference to validate and calibrate other the probe data 112. Specifically, the ground truth data 116 may serve as a benchmark to ensure the accuracy of probe data 112. In an embodiment, the ground truth data 116 may include accurate latitude and longitude co-ordinates of the road segment associated with the probe data 112. Further the ground truth data 116 may further include other parameters (such as allowed speed, and a directionality) of the road segment.

At 304, an anomaly detection operation may be executed. In the anomaly detection operation, the system 102 may be configured to detect a set of anomalies that may be associated with the probe data 112. In an embodiment, the set of anomalies may be present in the probe data 112 due to variety of reasons occurring during the capturing of the probe data 112, the processing of the probe data 112, a transmission of the probe data 112, or a storage of the probe data 112. Such reasons may include, but not limited to, poor satellite signals causing inaccurate location data during probe data capturing operation, faulty sensors or hardware issues in the vehicle capturing the probe data, sudden changes in GPS signals due to interference, temporary errors in data transmission from the vehicle, and malfunctioning speedometer or compass of the vehicle.

The system 102 may be configured to detect the set of anomalies associated with the probe data 112. The set of anomalies may include at least one of an invalid probe, a distant probe, a parking probe, a spiked value probe, and a zero-speed value probe. In an embodiment, the system 102 may be configured to apply a set of criteria on the received set of probe data records 114 to detect the set of anomalies associated with each probe data record of the set of probe data records 114. Specifically, the system 102 may be configured to apply at least one of a map matching technique or a filtering technique on each probe data record of the set of probe data records 114 to detect the set of anomalies. In an embodiment, the filtering technique may correspond to a Kalman filtering technique.

In an embodiment, the set of criteria for detecting the invalid probe anomaly in the probe data 112 may include a first criterion associated with speed information within a corresponding probe data record, a second criterion associated with heading information within the corresponding probe data record, a third criterion associated with location information within the corresponding probe data record, a fourth criterion associated with a timestamp associated with the corresponding probe data record, and a fifth criterion associated with duplicate probe data records within the probe data 112.

In an embodiment, the set of criteria for detecting the distant probe, and the spiked value probe anomaly in the probe data 112 may include a first criterion associated with location information within the corresponding probe data record. In an embodiment, the set of criteria for detecting the parking probe, and zero-speed value probe anomaly in the probe data 112 may include a first criterion associated with speed information within a corresponding probe data record. Details about each criteria of the set of criteria are provided, for example, in FIG. 5.

At 306, an anomaly score assignment operation may be executed. In the anomaly score assignment operation, the system 102 may be configured to assign an anomaly score to each probe data record of the set of probe data records 114 based upon the detected set of anomalies that may be associated with the corresponding probe data record. The anomaly score may be a numerical value and may be indicative of a degree of deviation of corresponding probe data record from the ground truth data associated with the corresponding probe data record. Specifically, the system 102 may be configured to apply at least one of a map matching technique on each probe data record of the set of probe data records 114 to determine the degree of deviation of corresponding probe data record from the ground truth data and further assign the anomaly score based on the determined the degree of deviation. Details about the map matching technique are known in the art and have been omitted for the sake of brevity.

At 308, a dataset generation operation may be executed. In the dataset generation operation, the system 102 may be configured to generate a training dataset based on the probe data 112, the detected set of anomalies, and the assigned anomaly score. Specifically, the training dataset may include the probe data 112, the detected set of anomalies, and the anomaly score assigned to each probe data record of the set of probe data records 114. In an embodiment, the training dataset may include a plurality of training samples. Each training sample may include a probe record, the set of anomalies that may be associated with the corresponding probe record, and the anomaly score assigned to the probe record. Based on the training dataset, the ML model 106 may learn to how to make predictions such as detection of the set of anomalies. Details about the training dataset are provided, for example, in FIG. 3B.

At 310, an ML model training operation may be executed. In the ML model training operation, the system 102 may be configured to train the ML model 106 based on the generated training dataset. In an embodiment, the ML model may be trained to detect the set of anomalies in the probe data 112. In another embodiment, the ML model 106 may be trained to generate a probe data quality score associated with the probe data 112. In an embodiment, the ML model 106 may be trained to generate the probe data quality score for the probe data 112 based on a count of the set of probe data records 114 included in the probe data 112, the predefined weight assigned to each of the detected set of anomalies, and the determined anomaly score to each probe data record of the set of probe data records 114. Specifically, the system 102 may be configured to generate the probe data quality score using the equation (1) provided below:

$$P . D . Q . S = \frac{1 - ( {W}_{1} \cdot {Q}_{1} + {W}_{2} \cdot {Q}_{2} + {W}_{3} \cdot {Q}_{3} + {W}_{4} \cdot {Q}_{4} + {W}_{5} \cdot {Q}_{5} )}{N} X 100 \qquad ( 1 )$$

Where,
P.D.Q.S corresponds to the probe data quality score,
W₁ corresponds to a first predefined weight assigned to the “invalid probe” anomaly,
W₂ corresponds to a second predefined weight assigned to the “distant probe” anomaly,
W₃ corresponds to the third predefined weight assigned to the “parking probe” anomaly,
W₄ corresponds to the fourth predefined weight assigned to the “spiked value probe” anomaly,
W₅ corresponds to the fifth predefined weight assigned to the “zero-speed value probe” anomaly,
Q₁ corresponds to the first anomaly score associated with the “invalid probe” anomaly,
Q₂ corresponds to the second anomaly score associated with the “distant probe” anomaly,
Q₃ corresponds to the third anomaly score associated with the “parking probe” anomaly,
Q₄ corresponds to the fourth anomaly score associated with the “spiked value probe” anomaly,
Q₅ corresponds to the anomaly score associated with the “zero-speed value probe” anomaly, and
N corresponds to the count of the set of probe data records 114 in the probe data 112.

The estimated probe data quality score may be of a numerical value and may be indicative of the quality of the probe data 112 that may be collected on the road segment. In an embodiment, the probe data quality score may be used to filter out vendors that provide probe data 112 with low probe data quality score.

FIG. 3B is a block diagram 300B that illustrates training of the ML model 106 for the detection of the set of anomalies and generation of the probe data quality score, in accordance with an embodiment of the disclosure. FIG. 3B is explained in conjunction with elements from FIG. 1A, FIG. 1B, FIG. 1C, FIG. 1D, FIG. 1E, FIG. 2, and FIG. 3A. With reference to FIG. 3B, there is shown the block diagram 300B of the system 102 that includes the ML model 106. There is further shown a training dataset 312, detected anomalies 314, and a probe data quality score 316.

In an embodiment, the system 102 may be configured to train the ML model 106. The ML model 106 may be trained on the training dataset 312 as discussed in FIG. 3A. The training dataset 312 may include the probe data 112, the detected set of anomalies, and the assigned anomaly score, and may correspond to a collection of examples that may be used to train the ML model 106 to make accurate predictions or classifications. The training of the ML model 106 may be an essential component in a machine learning process as it helps the ML model 106 to learn patterns and relationships within input features (i.e., the probe data 112, and the detected set of anomalies).

In an embodiment, the training dataset 312 may include historical probe data, detected a historical set of anomalies, corresponding historical probe data quality scores. In an embodiment, the training dataset 312 may also historical probe data quality scores associated with historical probe data. The training dataset 312 may include the plurality of training samples. In an embodiment, the system 102 may be configured to receive a first training sample of the plurality of training samples. The first training sample of the plurality of training samples may include the first historical probe data, the detected set of anomalies assigned to each probe data record of the first historical probe data, and an historical anomaly score assigned to each probe data record of the first historical probe data. Similarly, a second training sample of the plurality of training samples may include second historical probe data, the detected set of anomalies assigned to each probe data record of the second historical probe data, and an historical anomaly score assigned to each probe data record of the second historical probe data. Similarly, a Nth training sample of the plurality of training samples may include Nth historical probe data, the detected set of anomalies assigned to each probe data record of the Nth historical probe data, and an historical anomaly score assigned to each probe data record of the Nth historical probe data.

The system 102 may be configured to train the ML model 106 using each training sample of the plurality of training samples included in the training dataset 312 to output the detected anomalies associated with the probe data (that will be provided as input to the ML model 106) and the probe data quality score 316. In an embodiment, the training of the ML model 106 may cause the ML model 106 to generate the output as a function of the probe data. The system 102 may be further configured to estimate the probe data quality score 316 based at least in part on the output of the ML model 106.

In another embodiment, the system 102 may be configured to generate a new training sample to be included in the training dataset 312. The new training sample may include the probe data 112, and the detecting set of anomalies associated with the probe data 112, and the assigned anomaly score for the corresponding probe data quality score. The system 102 may be further configured to re-train the ML model 106 using the generated new training sample. Therefore, the ML model 106 may be re-trained even when the ML model 106 is deployed in real-life scenarios.

It may be noted that the training dataset 312 may be carefully selected and must be representative of a real-world problem of detection of the set of anomalies and generation of the probe data quality score. The training dataset 312 may cover various scenarios and may adequately capture the variability and complexity of the problem of detection of the set of anomalies and generation of the probe data quality score. In addition, it is important to have a sufficient amount of diverse and well-labeled data in the training dataset 312 to train the ML model 106 effectively.

In an embodiment, the ML model 106 may be categorized as a sequence-to-sequence-based ML model. Specifically, the ML model 106 may correspond to an attention-based encoder-decoder ML model. In an embodiment, the ML model 106 may include multiple ML models that may be connected with each other to output the probe data quality score.

In another embodiment, the input data (i.e., the probe data 112) to the ML model 106 may include location points indicative of the location of the corresponding probe point, and the ML model 106 may include a concatenate attention mechanism, which takes encoder and decoder outputs to find the relation between the input data and concatenate to get better results.

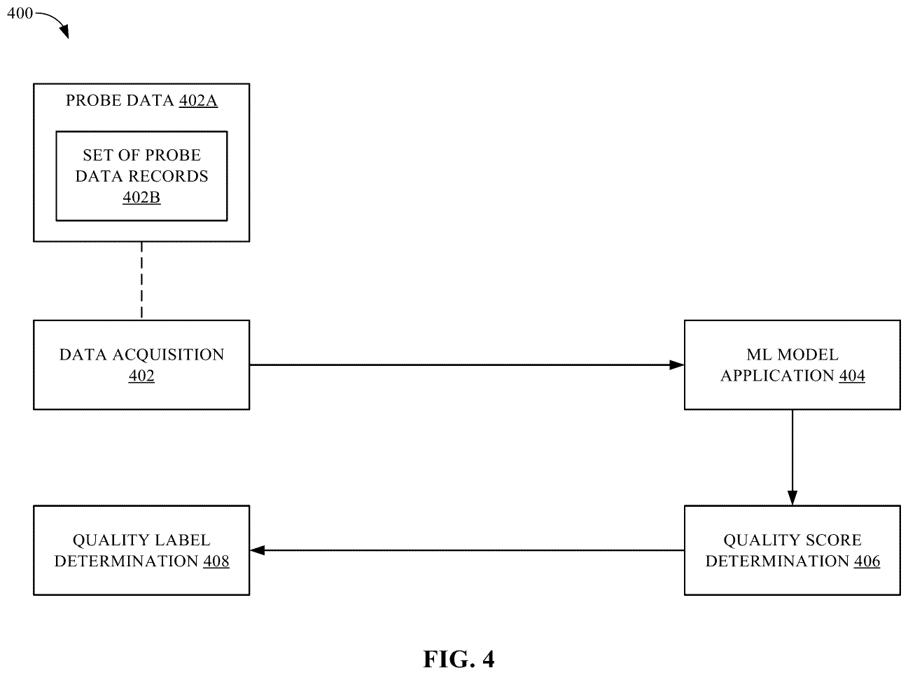

FIG. 4 is a block diagram 400 that illustrates exemplary operations for determination of quality label for probe data, in accordance with an embodiment of the disclosure. FIG. 4 is explained in conjunction with elements from FIG. 1A, FIG. 1B, FIG. 1C, FIG. 1D, FIG. 1E, FIG. 2, FIG. 3A, and FIG. 3B. With reference to FIG. 4, there is shown the block diagram 400 that illustrates exemplary operations from 402 to 408, as described herein. The exemplary operations illustrated in the block diagram 400 may start at 402 and may be performed by any computing system, apparatus, or device, such as by the system 102 of FIG. 1A or the processor 202 of FIG. 2. Although illustrated with discrete blocks, the exemplary operations associated with one or more blocks of the block diagram 400 may be divided into additional blocks, combined into fewer blocks, or eliminated, depending on the particular implementation.

At 402, a data acquisition operation may be executed. In the data acquisition operation, the system 102 may be configured to obtain probe data 402A. Specifically, the data reception module 202A of the processor 202 may be configured to obtain the probe data 404A. In an embodiment, the probe data 404 may be an exemplary embodiment of the probe data 112 and may be associated with the road segment. In an embodiment, the probe data 404A may be different from the probe data 112 and may be associated with a first road segment. For example, the ML model 106 may be trained on the probe data 112 associated with the road segment with the functional class “3” in “A” region in a first country (say Germany) whereas the probe data 402A may be associated with the road segment with the functional class “3” in “B” region in a second country (say France).

In an embodiment, the probe data 402A may include a set of probe data records 402B. Each probe data record of the set of probe data records 402B may be associated with a probe point at which parameters of the probe data record may be captured. Similar to the set of probe data records 114, each probe data record of the set of probe data records 402B may include at least one of location information associated with the corresponding probe point, timestamp information associated with capturing the corresponding probe point, speed information associated with the capturing of the corresponding probe point, and heading information associated with the capturing of the corresponding probe point.

At 404, an ML model application operation may be executed. In the ML model application operation, the system 102 may be configured to apply the ML model 106 on the set of probe data records 402B. The ML model 106 may be a pre-trained that may be trained using the training dataset as discussed in FIG. 3. Specifically, the ML model 106 may be trained to detect a set of anomalies associated with the probe data 402A and to further assign an anomaly score to each probe data record of the set of probe data records 402B based on the detected set of anomalies.

In an embodiment, the system 102 may be configured to apply the ML model 106 on the set of probe data records 402B to determine an anomaly score for each probe data record of the set of probe data records 402B. As discussed above, the anomaly score may be a numerical value and may be indicative of the detected set of anomalies that may be associated with the corresponding probe data record. As discussed above, the detected set of anomalies may include at least one of the invalid probe, the distant probe, the parking probe, the spiked value probe, and the zero-speed value probe. In an embodiment, the anomaly score may be assigned based on a predefined weight assigned to each of the detected set of anomalies. Specifically, the predefined weight may be assigned based on the functional class and the region type of the road segment associated with the probe data 402A.

In an alternate embodiment, the system 102 may be configured to identify one or more probe data records with missing speed and heading data. Based on the identified probe data records with missing speed and heading data, the system 102 may be configured to assign the anomaly score to each probe data record of the set of probe data records 402B.

At 406, a quality score determination operation may be executed. In the quality score determination operation, the system 102 may be configured to determine a probe data quality score associated with the probe data 402A. In an embodiment, the probe data quality score associated with the probe data 402A may be a numerical value that may be indicative of a quality of the probe data 402A. The probe data quality score may be determined based on the anomaly score that may be associated with each probe data record of the set of probe data records 402B. In an embodiment, the probe data quality score may be determined by using equation (1) discussed in FIG. 3.

At 408, a quality label determination operation may be executed. In the quality label determination operation, the system 102 may be configured to determine a quality label that may be associated with the probe data 402A. The quality label associated with probe data may correspond to a descriptor or a tag that may indicate a reliability, an accuracy, and an overall quality of the probe data 404 that may be collected by the one or more vehicles. The quality label may be determined based on the probe data quality score associated with the probe data 402A. In an embodiment, the system 102 may compare the probe data quality score with a score threshold. In an embodiment, the score threshold may correspond to a numerical value below which a first quality label may be assigned to the probe data 402A. In case the probe data quality score is equal to or greater than the score threshold, the system 102 may assign a second quality label to the probe data 402A. In an alternative embodiment, the score threshold may be a range that may have an upper limit, a middle limit, and a lower limit. In case the probe data quality score is below the lower limit, the system 102 may assign a first quality label to the probe data 402A. In case the probe data quality score lies between the lower limit and the middle limit, the system 102 may assign a second quality label to the probe data 402A. In case the probe data quality score lies between the middle limit and the upper limit, the system 102 may assign a third quality label to the probe data 402A and in case the probe data quality score lies above the upper limit, the system 102 may assign a fourth quality label to the probe data 402A.

In an embodiment, the system 102 may be configured to output the probe data quality score and the quality label. In an embodiment, the output of the probe data quality score and the quality label may correspond to storage of the probe data 402A, the probe data quality score, and the determined quality label in one or more databases (such as the map database 108B). The system 102 may be further configured to use the probe data quality score and the quality label for the improvement of one or more services (such as traffic management) provided by the mapping platform 108.

FIG. 5 is a block diagram 500 that depicts operations for the assignment of set of anomalies to the set of probe data records of the probe data, in accordance with an embodiment of the disclosure. FIG. 5 is explained in conjunction with elements from FIG. 1A, FIG. 1B, FIG. 1C, FIG. 1D, FIG. 1E, FIG. 2, FIG. 3A, FIG. 3B, and FIG. 4. With reference to FIG. 5, there is a shown a block for the set of criteria 502, and an anomaly assignment operation at 504. There is further shown the system 102 and the ML model 106 of FIG. 1A.

In an embodiment, the system 102 may receive the probe data 112 may include the set of probe data records 114. During the collection of the probe data 112, some probe data may be erroneous due to a variety of issues that may be sensor inaccuracies, environmental factors, signal interference, multipath effects, data processing errors, and the like. Specifically, such probe data records may have anomalies such as an invalid probe, a distant probe, a parking probe, a spiked value probe, and a zero-speed value probe. To detect the set of anomalies that may be associated with the probe data record, the system 102 may apply the set of criteria on each probe data record of the set of probe data records 114.

By way of example and not limitation, the set of criteria may include a first set of criteria, a second set of criteria, a third set of criteria, a fourth set of criteria, a fifth set of criteria, and a sixth set of criteria. Specifically, the system 102 may apply the first set of criteria to detect the “invalid probe” anomaly in the probe data 112. The system 102 may apply the second set of criteria to detect the “distant probe” anomaly in the probe data 112. The system 102 may apply the third set of criteria to detect the “parking probe” anomaly in the probe data 112. The system 102 may apply the fourth set of criteria to detect the “spiked value probe” anomaly in the probe data 112. Similarly, the system 102 may apply the fifth set of criteria to detect the “zero-speed value probe” anomaly in the probe data 112 and the sixth set of criteria to detect the “missing speed and heading value probe” anomaly in the probe data 112.

In some cases, the probe data 112 may include some probe data records that may be invalid and must be identified for the determination of the probe data quality score accurately. Based on the reception of the probe data 112, the system 102 may apply the first set of criteria to assign the “invalid probe” anomaly to the corresponding probe data record. In an embodiment, the first set of criteria may include at least one of a first criterion associated with speed information within a corresponding probe data record, a second criterion associated with heading information within the corresponding probe data record, a third criterion associated with location information within the corresponding probe data record, a fourth criterion associated with a timestamp associated with the corresponding probe data record, and a fifth criterion associated with duplicate probe data records within the probe data.

In accordance with the first criterion, if the speed value in the probe data record is less than a first speed value or greater than a second speed value, then the corresponding probe data record may be assigned with the “invalid probe” anomaly indicative of an invalid probe data record. By way of example and not limitation, if the speed value is less than 0 miles per hour (mph) or greater than 400 mph, then the corresponding probe data record may be assigned with the “invalid probe” anomaly.

In accordance with the second criterion, if the heading value in the probe data record is less than the first heading value or greater than a second heading value, then the corresponding probe data record may be assigned with the “invalid probe” anomaly. By way of example and not limitation, if the heading value is less than 0 or greater than 359, then the corresponding probe data record may be assigned with the “invalid probe” anomaly.

In accordance with the third criterion, if the latitude value in the probe data record is less than a first latitude value or greater than a second latitude value, then the corresponding probe data record may be assigned with the “invalid probe” anomaly. By way of example and not limitation, if the latitude value is less than −90 degrees or greater than 90 degrees, then the corresponding probe data record may be assigned with the first label.

Furthermore, if the longitude value in the probe data record is less than a first longitude value or greater than a second longitude value, then the corresponding probe data record may be assigned with the “invalid probe” anomaly. By way of example and not limitation, if the longitude value is less than −180 degrees or greater than 180 degrees, then the corresponding probe data record may be assigned with the “invalid probe” anomaly.

In accordance with the fourth criterion, if the timestamp of multiple probe data records is same, then each probe data record may be assigned with the “invalid probe” anomaly. In accordance with the fifth criterion, if there are duplicate probe data records in the set of probe data records, then each duplicate probe data record may be assigned with the “invalid probe” anomaly. In accordance with a sixth criterion, if the location information is the same for consecutive probe data records, then the speed value of such probe data records must not be zero. If the location information is the same for consecutive probe data records and the speed value of such probe data records is zero, then the system 102 may be configured to assign the “invalid probe” anomaly to each of the consecutive probe data records until the speed value changes from zero.

In an embodiment, for the probe data records to be considered valid probe data records, the speed value should be between 0 and 400, the heading value should be between 0 and 359, the latitude should be between −90 and +90, the longitude should be between −180 and +180. Furthermore, there may not be duplicate records, the same timestamp should not be present for different probe data records, and the same location value should not be present for consecutive records when the speed is not zero. Based on the application of the first set of criteria, the system 102 may be configured to assign the “invalid probe” anomaly to the set of probe data records 114.

In an embodiment, the system 102 may apply the second set of criteria to assign the “distant probe” anomaly to the corresponding probe data record. To apply the second set of criteria, the system 102 may be configured to determine a mid-point of the road segment on which the probe data was captured. The mid-point of the road segment may be determined from the map database 108B. The system 102 may be further configured to determine a first distance between a location associated with each probe data record of the set of probe data records 114 and the determined mid-point of the road segment. The system 102 may be further configured to compare the determined first distance with a first pre-determined threshold. In an embodiment, the first pre-determined threshold may correspond to 10 meters.

In case the distance between the location associated with each probe data record of the set of probe data records 114 and the determined mid-point of the road segment is greater than the first pre-determined threshold, then the corresponding probe data record may be assigned with the “distant probe” anomaly. Based on the application of the second set of criteria, the system 102 may be configured to assign the “distant probe” anomaly to the set of probe data records 114. In an embodiment, the “distant probe” may also be referred as “probes away from road.”

In an embodiment, the system 102 may be configured to determine the second predefined weight (W₂) assigned to the “distant probe” anomaly based on the determined first distance and the first pre-determined threshold using the equation (2) as provided below:

$${W}_{2} = min ( 1 , \frac{( first distance - first predetermined threshold}{15} ) \qquad ( 2 )$$

Where,
W₂ corresponds to the predefined weight assigned to the “distant probe” anomaly.

The system 102 may apply the third set of criteria to assign the “parking probe” anomaly to the set of probe data records 114. The third set of criteria may include the second set of criteria and an additional criteria associated with the speed value of the corresponding probe data record. To apply the third set of criteria, the system 102 may be configured to apply the second set of criteria and further apply the additional criteria associated with the speed value. The additional criteria associated with the speed value may indicate that the speed value should be less than a pre-defined speed limit. By way of example and not limitation, if the speed value of the second set of probe data records is less than 5 mph, then such probe data records may be assigned with the “parking probe” anomaly.

In some cases, some probe data records may be wrongly assigned with the “parking probe” anomaly. To detect such probe data records, the system 102 may be configured to use Kalman predicted point. Specifically, the system 102 may be configured to use Kalman predicted point. If the distance between the parking probe and Kalman predicted point is more than 10 meters, then such probe data records may be assigned with the “distant probe” anomaly and not the “parking probe” anomaly.

As discussed above, the third set of criteria may include at least one of a first criterion associated with speed information within the corresponding probe data record (i.e. the speed value may be less than 5 mph), a second criterion associated with the distance between a location associated with each probe data record of the set of probe data records and a midpoint of the road segment (i.e. the distance between the midpoint of the road segment and the location of the corresponding probe point may be less than 10 meters), and a third criterion associated with a comparison of the distance between a Kalman predicted probe point and the corresponding probe point with a second pre-determined threshold of 10 meters.

By way of example and not limitation, if probe points are away from the road and the corresponding speed value of the probe data record is less than 5 mph, then the system 102 may assign the “distant probe” anomaly to such probe data records. In parking probes, there may be a possibility of having bad probes as well. To detect such probe points, the system 102 may use Kalman prediction. If the distance between the parking probe and Kalman predicted point is away from each other (by the second pre-determined threshold of 10 meters) then such probe points may be assigned with the “distant probe” anomaly and not the “parking probe” anomaly.

In an embodiment, system 102 may apply the fourth set of criteria to assign the “spiked value probe” to the corresponding probe data record. The fourth set of criteria may be associated with a distance between the Kalman-predicted probe point and the location associated with the corresponding probe point. To apply the fourth set of criteria, the system 102 may be configured to determine a second distance between the Kalman-predicted probe point and the location at which the corresponding probe data record may be captured. The system 102 may be further configured to compare the determined second distance with a third pre-determined threshold. The system 102 may be further configured to assign the “spiked value probe” anomaly to the corresponding probe data record based on the application of the fourth set of criteria.

By way of example and not limitation, if the location information indicates that the distance between the location of the probe point and the Kalman predicted point is more 4 meters (i.e., the third pre-determined threshold), and if the probe data record is assigned with the “distant probe” anomaly or the “parking probe” anomaly, then the probe data record may also be assigned with the “spiked value probe” anomaly.

In an embodiment, the system 102 may apply a fifth set of criteria on the set of probe data records to assign the “zero-speed value probe” anomaly to the corresponding probe data record. The fifth set of criteria may be associated with the speed value of each probe data record of the set of probe data records. In an embodiment, if more than 50% of probe data records captured by the vehicle in a single session have the speed value as zero, then only zero speed value probe data records may be considered. In an embodiment, the probe data records assigned with the “parking probe” anomaly subtracted from total number of zero-speed probe data records to determine the probe data records to be assigned with the “zero-speed value probe” anomaly.

In an embodiment, the system 102 may apply a sixth set of criteria on the set of probe data records to assign the “missing speed and heading value probe” anomaly to the corresponding probe data record. The sixth set of criteria may be associated with the speed value and heading value of each probe data record of the set of probe data records. In an embodiment, if the probe data record has zero speed value or zero heading value, then the corresponding probe data records may be assigned with the “missing speed and heading value probe” anomaly.

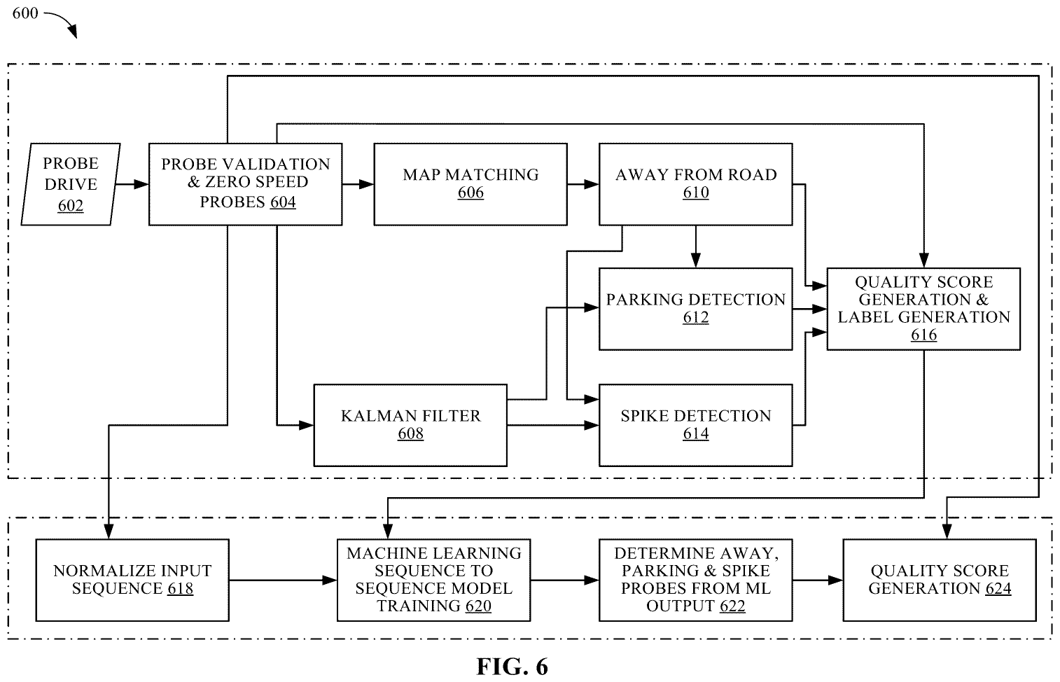

FIG. 6 is a block diagram 600 that illustrates training of the ML model and determination of the quality label for the probe data using the trained ML model, in accordance with an embodiment of the disclosure. FIG. 6 is explained in conjunction with elements from FIG. 1A, FIG. 1B, FIG. 1C, FIG. 1D, FIG. 1E, FIG. 2, FIG. 3A, FIG. 3B, FIG. 4, and FIG. 5. With reference to FIG. 6, there is shown the block diagram 600 that may include a set of blocks for training of the ML model and determination of the quality label for the probe data using the trained ML model.

At 602, the system 102 may receive the probe data 112 (also called probe drive) that may include the set of probe data records 114. The system 102 may further apply a probe validation operation, at 604, to detect the invalid probe data records and zero-speed probe data records. The system 102 may further execute the map matching technique on the probe data at 606. The map matching technique may be executed on each probe data record of the et of probe data records 114 and may be based on the ground truth data 116 associated with the probe data 112. Based on the execution of the map matching technique, the system 102 may further detect the distant probes at 610. The system 102 may apply Kalman filter on the probe records at 608 to detect the parking probes at 612, and spiked-value probes at 614. Once the invalid probes, the zero-speed probe, the distant probes, the parking probes, and the spiked value probes are detected, the system 102 may determine the probe data quality score and quality label associated with the probe data at 616.

In an embodiment, the system 102 may be configured to normalize the input sequence at 618. Specifically, the system 102 may be configured to normalize the probe data 112. The system 102 may further train the ML model 106 using the normalized input sequence and the probe data quality score and quality label associated with the probe data 112 at 620. At 622, the system 102 may be further configured to apply the ML model 106 to determine the distant probes, the parking probes, the spiked value probes based on the output of the ML model 106. At 624, the system 102 may be further configured to determine the quality score associated with the probe data 112 based on the determined distant probes, parking probes, spiked value probes, the invalid probes, and the zero-speed value probes.

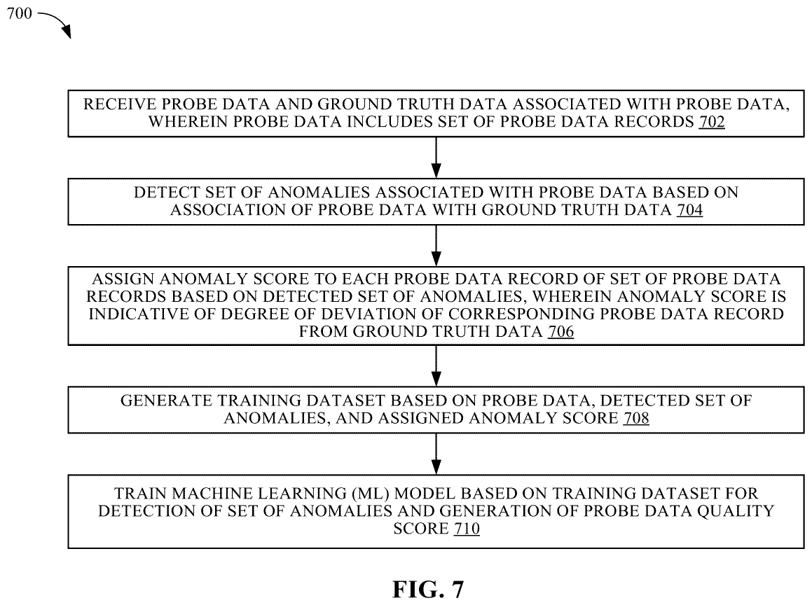

FIG. 7 is a flowchart 700 that illustrates an exemplary method for training of ML model for determination of quality label for probe data, in accordance with an embodiment of the disclosure. FIG. 7 is explained in conjunction with elements from FIG. 1A, FIG. 1B, FIG. 1C, FIG. 1D, FIG. 1E, FIG. 2, FIG. 3A, FIG. 3B, FIG. 4, FIG. 5, and FIG. 6. With reference to FIG. 7, there is shown the flowchart 700. The operations of the exemplary method may be executed by any computing system, for example, by the system 102 of FIG. 1A or the processor 202 of FIG. 2. The operations of the flowchart 700 may start at 702.

At 702, the probe data 112 and the ground truth data 116 associated with the probe data 112 may be received. The probe data includes the set of probe data records 114. In an embodiment, the processor 202 may be configured to receive the probe data 112 and the ground truth data 116 associated with the probe data 112, wherein the probe data 112 includes the set of probe data records 114. Details about the probe data 112 and the ground truth data 116 are provided, for example, in FIG. 3A.

At 704, the set of anomalies associated with the probe data 112 may be detected based on the association of the probe data 112 with the ground truth data 116. In an embodiment, the processor 202 may be configured to detect the set of anomalies associated with the probe data 112 based on the association of the probe data 112 with the ground truth data 116. Details about the set of anomalies are provided, for example, in FIG. 3A, FIG. 3B, and FIG. 5.

At 706, the anomaly score may be assigned to each probe data record of the set of probe data records 114 based on the detected set of anomalies. The anomaly score may be indicative of a degree of deviation of corresponding probe data record from the ground truth data 116. In an embodiment, the processor 202 may be configured to assign the anomaly score to each probe data record of the set of probe data records 114 based upon the detected set of anomalies, wherein the anomaly score is indicative of the degree of deviation of corresponding probe data record from the ground truth data 116. Details about the anomaly score are provided, for example, in FIG. 3A.

At 708, the training dataset may be generated based on the probe data 112, the detected set of anomalies, and the assigned anomaly score. In an embodiment, the processor 202 may be configured to generate the training dataset 312 based on the probe data 112, the detected set of anomalies, and the assigned anomaly score. Details about the training dataset are provided, for example, in FIG. 3A, and FIG. 3B.

At 710, the ML model 106 may be trained based on the training dataset for the detection of the set of anomalies and generation of the probe data quality score 316. In an embodiment, the processor 202 may be configured to train the ML model 106 based on the training dataset 312 for the detection of the set of anomalies and generation of the probe data quality score 316. Details about the training of the ML model 106 are provided, for example, in FIG. 3A, and FIG. 3B. Control may pass to the end.

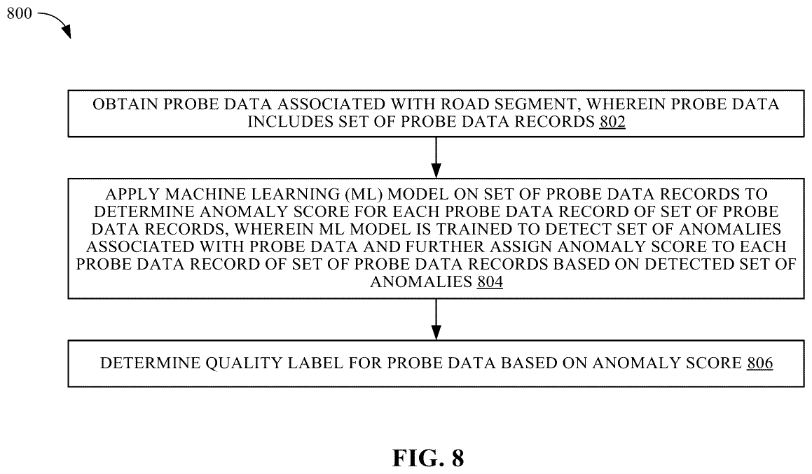

FIG. 8 is a flowchart 800 that illustrates an exemplary method for determination of quality label for the probe data, in accordance with an embodiment of the disclosure. FIG. 8 is explained in conjunction with elements from FIG. 1A, FIG. 1B, FIG. 1C, FIG. 1D, FIG. 1E, FIG. 2, FIG. 3A, FIG. 3B, FIG. 4, FIG. 5, FIG. 6, and FIG. 7. With reference to FIG. 8, there is shown the flowchart 800. The operations of the exemplary method may be executed by any computing system, for example, by the system 102 of FIG. 1A or the processor 202 of FIG. 2. The operations of the flowchart 800 may start at 802.

At 802, the probe data 112 associated with a road segment may be obtained. The probe data 402A may include the set of probe data records 402B. In an embodiment, the processor 202 may be configured to obtain the probe data 402A associated with the road segment, wherein the probe data 402A includes the set of probe data records 402B. Details about the set of probe data are provided, for example, in FIG. 3A.

At 804, the ML model 106 may be applied on the set of probe data records 402B to determine the anomaly score for each probe data record of the set of probe data records 402B. The ML model 106 may be trained to detect the set of anomalies associated with the probe data 402A and further assign an anomaly score to each probe data record of the set of probe data records 402B based on the detected set of anomalies. In an embodiment, the processor 202 may be configured to apply the ML model 106 on the set of probe data records 402B to determine an anomaly score for each probe data record of the set of probe data records 402B, wherein the ML model 106 is trained to detect the set of anomalies associated with the probe data 402A and further assign an anomaly score to each probe data record of the set of probe data records 402B based on the detected set of anomalies. Details about the application of the ML model 106 are provided, for example, in FIG. 4.

At 806, the quality label may be determined for the set of the probe data 402A based on the anomaly score. In an embodiment, the processor 202 may be configured to determine the quality label for the probe data 402A based on the anomaly score. Details about the quality label are provided, for example, in FIG. 4. Control may pass to the end.

Accordingly, blocks of the flowchart 700 and the flowchart 800 support combinations of means for performing the specified functions and combinations of operations for performing the specified functions. It will also be understood that one or more blocks of the flowchart 700 and the flowchart 800, and combinations of blocks in the flowchart 700 and the flowchart 800, can be implemented by special-purpose hardware-based computer systems that perform the specified functions, or combinations of special-purpose hardware and computer instructions.

Alternatively, the system 102 may comprise means for performing each of the operations described above. In this regard, according to an example embodiment, examples of means for performing operations may comprise, for example, the processor 202 and/or a device or circuit for executing instructions or executing an algorithm for processing information as described above.

Returning to FIG. 1A, the system 102 may include suitable logic, circuitry, interfaces, and/or code that may be configured to estimate a probe data quality score for the probe data 112. Specifically, the system 102 may be configured to receive the probe data 112 from the one or more data sources 104. The probe data 112 may include the set of probe data records 114 that may be captured by one or more sensors mounted on one or more vehicles travelling on a road segment in a geographical region (such as a country). The system 102 may be further configured to receive ground truth data 116 that may be associated with the probe data 112. The system 102 may further detect a set of anomalies associated with the probe data 112 based on an association of the probe data with the ground truth data. The system 102 may further assign an anomaly score to each probe data record of the set of probe data records based upon the detected set of anomalies. The anomaly score may be indicative of a degree of deviation of corresponding probe data record from the ground truth data. The system 102 may further generate a training dataset based on the probe data, the detected set of anomalies, and the assigned anomaly score. The system 102 may further train the ML model 106 based on the training dataset for the detection of the set of anomalies and generation of a probe data quality score. Examples of the system 102 may include, but are not limited to, a computing device, a mainframe machine, a server, a computer workstation, and/or any other device with data processing capabilities. In an example embodiment, the system 102 may be the processing server 108A of the mapping platform 108 and therefore may be co-located with or within the mapping platform 108.

In another embodiment, the system 102 may be embodied as a cloud-based service, a cloud-based application, a cloud-based platform, a remote server-based service, a remote server-based application, a remote server-based platform, or a virtual computing system. In yet another example embodiment, the system 102 may be an OEM (Original Equipment Manufacturer) cloud.

Each of the one or more data sources 104 may include suitable logic, circuitry, interfaces, and/or code that may be configured to store the probe data 112 and the ground truth data 116 associated with the probe data 112. Each of the one or more data sources 104 may further transmit the probe data 112 and the ground truth data 116 associated with the probe data 112 to the system 102. In an embodiment, the probe data 112 (also known as floating car data (FCD)), may be captured by one or more sensors installed on one or more vehicles travelling on the road segment. As discussed above, the probe data 112 may include the set of probe data records 114. Each probe data record may be associated with a probe point. Each probe point includes at least one of location information, timestamp information, speed information, and heading information associated with a vehicle.

In an embodiment, the one or more data sources 104 may be associated with one or more vendors who may be suppliers of the probe data 112 that may be captured using the one or more vehicles traveling on the road segment. Examples of each of the one or more data sources 104 may include, but are not limited to, a database, and a repository.

The ML model 106 may be a computational network or a system of artificial neurons, arranged in a plurality of layers, as nodes. The plurality of layers of the ML model 106 may include an input layer, one or more hidden layers, and an output layer. Each layer of the plurality of layers may include one or more nodes (or artificial neurons). Outputs of all nodes in the input layer may be coupled to at least one node of the hidden layer(s). Similarly, inputs of each hidden layer may be coupled to outputs of at least one node in other layers of the ML model 106. Outputs of each hidden layer may be coupled to inputs of at least one node in other layers of the ML model 106. Node(s) in the final layer may receive inputs from at least one hidden layer to output a result. The number of layers and the number of nodes in each layer may be determined from the hyper-parameters of the ML model 106. Such hyper-parameters may be set before or while training the ML model 106 on a training dataset.

Each node of the ML model 106 may correspond to a mathematical function (e.g., a sigmoid function or a rectified linear unit) with a set of parameters, tunable during the training of the network. The set of parameters may include, for example, a weight parameter, a regularization parameter, and the like. Each node may use the mathematical function to compute an output based on one or more inputs from nodes in other layer(s) (e.g., previous layer(s)) of the ML model 106. All or some of the nodes of the ML model 106 may correspond to the same or a different mathematical function.

In training of the ML model 106, one or more parameters of each node of the ML model 106 may be updated based on whether an output of the final layer for a given input (from the training dataset) matches a correct result based on a loss function for the ML model 106. The above process may be repeated for the same or a different input until a minima of loss function may be achieved, and a training error may be minimized. Several methods for training are known in art, for example, gradient descent, stochastic gradient descent, batch gradient descent, gradient boost, meta-heuristics, and the like.

The ML model 106 may include electronic data, such as, for example, a software program, code of the software program, libraries, applications, scripts, or other logic or instructions for execution by a processing device, such as circuitry. The ML model 106 may include code and routines configured to enable a computing device, such as the system 102, to perform one or more operations. Additionally, or alternatively, the ML model 106 may be implemented using hardware including a processor, a microprocessor (e.g., to perform or control performance of one or more operations), a field-programmable gate array (FPGA), or an application-specific integrated circuit (ASIC). Alternatively, in some embodiments, the ML model 106 may be implemented using a combination of hardware and software. Although in FIG. 1A, the ML model 106 is shown as integrated within the system 102, the disclosure is not so limited. Accordingly, in some embodiments, the ML model 106 may be a separate entity from the system 102, without deviation from scope of the disclosure. In an embodiment, the ML model 106 may be categorized as a sequence-to-sequence-based ML model. An example of the ML model 106 may be an attention-based encoder-decoder ML model or a recurrent neural network.

The mapping platform 108 may comprise suitable logic, circuitry, and interfaces that may be configured to store one or more map attributes and sensor data associated with traffic on link segments and lane segments. The mapping platform 108 may be configured to store and update map data indicating the traffic data along with other map attributes, road attributes, and traffic entities, in the map database 108B. The mapping platform 108 may include techniques related to, but not limited to, geocoding, routing (multimodal, intermodal, and unimodal), clustering algorithms, machine learning in location-based solutions, natural language processing algorithms, and artificial intelligence algorithms. Data for different modules of the mapping platform 108 may be collected using a plurality of technologies including, but not limited to drones, sensors, connected cars, cameras, probes, and chipsets. In some embodiments, the mapping platform 108 may be embodied as a chip or chip set. In other words, the mapping platform 108 may comprise one or more physical packages (such as chips) that include materials, components, and/or wires on a structural assembly (such as a baseboard).

In some example embodiments, the mapping platform 108 may include the processing server 108A for carrying out the processing functions associated with the mapping platform 108 and the map database 108B for storing map data. In an embodiment, the processing server 108A may include one or more processors configured to process requests received from the system 102. The processors may fetch sensor data and/or map data from the map database 108B and transmit the same to the system 102 in a format suitable for use by the system 102.

Continuing further, the map database 108B may comprise suitable logic, circuitry, and interfaces that may be configured to store the sensor data and map data. In accordance with an embodiment, such sensor data may be updated in real-time or near real-time such as within a few seconds, a few minutes, or on an hourly basis, to provide accurate and up-to-date sensor data. The sensor data may be collected from any sensor that may inform the mapping platform 108 or the map database 108B of features within an environment that is appropriate for traffic-related services. In accordance with an embodiment, the sensor data may be collected from any sensor that may inform the mapping platform 108 or the map database 108B of features within an environment that is appropriate for mapping. For example, motion sensors, inertia sensors, image capture sensors, proximity sensors, LiDAR sensors, and ultrasonic sensors may be used to collect the sensor data. The gathering of enormous quantities of crowd-sourced data may facilitate the accurate modeling and mapping of an environment, whether it is a road link or a link within a structure, such as in an interior of a multi-level parking structure.

The map database 108B may further be configured to store the traffic-related data and road topology and geometry-related data for a road network as map data. The map data may also include cartographic data, routing data, and maneuvering data. The map data may also include, but is not limited to, locations of intersections, diversions to be caused due to accidents, congestions or constructions, suggested roads, or links to avoid, and an estimated time of arrival (ETA) depending on different links. In accordance with an embodiment, the map database 108B may be configured to receive the map data including the road topology and geometry-related attributes related to the road network from external systems, such as one or more of background batch data services, streaming data services, and third-party service providers, via the communication network 110.

In accordance with an embodiment, the map data stored in the map database 108B may further include data about changes in traffic situations registered by GPS provider(s), such as, but not limited to, incidents, road repairs, heavy rains, snow, fog, time of day, day of a week, holiday or other events which may influence the traffic condition of a link segment.

In some embodiments, the map database 108B may further store historical probe data for events (such as, but not limited to, traffic incidents, construction activities, scheduled events, and unscheduled events) associated with Point of Interest (POI) data records or other records of the map database 108B.

For example, the data stored in the map database 108B may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as a user equipment. The navigation-related functions may correspond to vehicle navigation, pedestrian navigation, navigation to a favored parking spot, or other types of navigation. While example embodiments described herein generally relate to vehicular travel, example embodiments may be implemented for bicycle travel along bike paths, boat travel along maritime navigational routes, etc. The compilation to produce the end-user databases may be performed by a party or entity separate from the map developer. For example, a customer of the map developer, such as a navigation device developer or other end user device developer, may perform compilation on the received map database 108B in a delivery format to produce one or more compiled navigation databases.

In some embodiments, the map database 108B may be a master geographic database configured on the side of the system 102. In accordance with an embodiment, a client-side map database 108B may represent a compiled navigation database that may be used in or with end-user devices to provide navigation instructions based on the traffic data, the traffic conditions, speed adjustment, ETAs, and/or map-related functions to navigate through the intersection connected links on the route.

In some embodiments, the map data may be collected by end-users who use vehicles on-board one or more sensors to detect data about various entities such as road objects, lane markings, links, and the like. These vehicles are also referred to as probe vehicles and form an alternate form of data source for map data collection, along with ground truth data. Additionally, data collection mechanisms like remote sensing, such as aerial or satellite photography may be used to collect the map data for the map database 108B.

For an example, the map database 108B may include lane and intersection data records or other data that may represent links in the route, pedestrian lane, or areas in addition to or instead of the vehicle lanes. The lanes and intersections may be associated with attributes, such as geographic coordinates, street names, lane identifiers, lane segment identifiers, lane traffic direction, address ranges, speed limits, turn restrictions at intersections, and other navigation-related attributes, as well as POIs, such as fueling stations, hotels, restaurants, museums, stadiums, offices, auto repair shops, buildings, stores, and parks. The map database 108B may additionally include data about places, such as cities, towns, or other communities, and other geographic features such as, but not limited to, bodies of water, and mountain ranges.

In some example embodiments, images received from the image source may be stored within the map database 108B of the mapping platform 108. In certain cases, the mapping platform 108, using the processing server 108A, may suitably process the received images. For example, such processing may include, suitably labeling the images based on corresponding associated lane and/or link, point of interest within the link and/or lane, and other information relating to the respective link and/or lane. Such labeled images may then be stored within the map database 108B as map data.

The system 102 may be communicatively coupled to the one or more data sources 104, and the mapping platform 108, via the communication network 110. In an embodiment, the system 102 may be communicatively coupled to other components not shown in FIG. 1A via the communication network 110. All the components in the network environment 100A may be coupled directly or indirectly to the communication network 110. The components described in the network environment 100A may be further broken down into more than one component and/or combined in any suitable arrangement. Further, one or more components may be rearranged, changed, added, and/or removed.

The communication network 110 may be wired, wireless, or any combination of wired and wireless communication networks, such as cellular, Wi-Fi, internet, local area networks, or the like. In some embodiments, the communication network 110 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

Returning to FIG. 2, the processor 202 of the system 102 may be configured to determine a quality label for the probe data 112. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

In an example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as 100A may be accessed using the communication interface 208 of the system 102. The communication interface 208 may provide an interface for accessing various features and data stored in the system 102.

In some embodiments, the processor 202 may be configured to provide Internet-of-Things (IoT) related capabilities to users of the system 102 disclosed herein. The IoT-related capabilities may in turn be used to provide smart city solutions by providing real-time probe data quality score. The I/O interface 206 may provide an interface for accessing various features and data stored in the system 102.

The data reception module 202A of the processor 202 may be configured to receive the probe data 112 and the ground truth data 116. In an embodiment, the probe data 112 and the ground truth data 116 may be received from the one or more data sources 104.

The ML model application module 202B of the processor 202 may be configured to apply the ML model 106 on the obtained probe data 112. The received probe data 112 may include the set of probe data records 114. The set of probe data records 114 may be associated with a set of probe points. Each probe data record of the set of probe data records may include at least one of location information associated with a corresponding probe point, timestamp information associated with capturing of the corresponding probe point, speed information associated with the capturing of the corresponding probe point, and heading information associated with the capturing of the corresponding probe point.

The quality label determination module 202C of the processor 202 may be configured to determine a quality label for the probe data 112. In an embodiment, the quality label for the probe data 112 may be associated with the road segment on which the probe data 112 was captured by the one or more vehicles.

The output module 202D of the processor 202 may be configured to output the determined quality label for the probe data 112. The output module 202D may be further configured to output the transmit the determined quality label to the mapping platform 108.

The memory 204 of the system 102 may be configured to store the probe data 112, the ground truth data 116, an anomaly score to each probe data record, the training dataset, and the determined quality label for the probe data 112. The memory 204 of the system 102 may be configured to store the ML model 106. The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein.

In some example embodiments, the I/O interface 206 may communicate with the system 102 and display the input and/or output of the system 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the system 102 may include a user interface circuitry configured to control at least some functions of one or more I/O interface elements such as a display and, in some embodiments, a plurality of speakers, a ringer, one or more microphones and/or the like. The processor 202 and/or I/O interface 206 circuitry comprising the processor 202 may be configured to control one or more functions of one or more I/O interface 206 elements through computer program instructions (for example, software and/or firmware) stored on a memory 204 accessible to the processor 202. The processor 202 may further render notifications associated with the navigation instructions, such as traffic data, traffic conditions, traffic congestion value, ETA, routing information, road conditions, driving instructions, etc., on the user equipment or audio or display onboard the vehicles via the I/O interface 206.

The communication interface 208 may comprise input interface and output interface for supporting communications to and from the system 102 or any other component with which the system 102 may communicate. The communication interface 208 may be any means such as a device or circuitry embodied in either hardware or a combination of hardware and software that is configured to receive and/or transmit data to/from a communications device in communication with the system 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms. In some embodiments, the communication interface 208 may enable communication with a cloud-based network to enable deep learning, such as using the ML model 106 (that may be hosted on the cloud-based network).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for training a machine learning model comprising:
receiving probe data and ground truth data associated with the probe data, wherein the probe data comprises of a set of probe data records;
detecting a set of anomalies associated with the probe data based on an association of the probe data with the ground truth data;
assigning an anomaly score to each probe data record of the set of probe data records based on the detected set of anomalies, wherein the anomaly score is indicative of a degree of deviation of corresponding probe data record from the ground truth data;
generating a training dataset based on the probe data, the detected set of anomalies, and the assigned anomaly score; and
training a machine learning (ML) model based on the training dataset for the detection of the set of anomalies and generation of a probe data quality score.

2. The method according to claim 1, wherein the detected set of anomalies comprises at least one of an invalid probe, a distant probe, a parking probe, a spiked value probe, and a zero-speed value probe.

3. The method according to claim 2, further comprising identifying one or more probe data records with missing speed and heading data, wherein the missing speed and heading data is further used to assign the anomaly score.

4. The method according to claim 1, further comprising detecting the set of anomalies based on an application of at least one of a map matching technique or a filtering technique on the set of probe data records and the ground truth data.

5. The method according to claim 4, wherein the filtering technique corresponds to a Kalman filtering technique.

6. The method according to claim 1, further comprising assigning the anomaly score based on a predefined weight assigned to each of the detected set of anomalies.

7. The method according to claim 6, further comprising assigning the predefined weight based on a functional class and a region type of a road segment associated with the probe data.

8. The method for training the machine learning model according to claim 1, further comprising:
generating artificial training data based on the probe data, the set of anomalies and the anomaly score; and
training the machine learning (ML) model based on the artificial training dataset for the detection of anomalies and generation of the probe data quality score.

9. The method of claim 1, wherein the ML model is categorized as a sequence-to-sequence-based ML model, and wherein the ML model corresponds to an attention-based encoder-decoder ML model.

10. A system comprising:
at least one processor; and
at least one memory including computer program code for one or more programs,
the at least one memory and the computer program code configured to, with the at least one processor, cause the system to perform at least the following:
obtain probe data associated with a road segment, wherein the probe data comprises of a set of probe data records;
apply a machine learning (ML) model on the set of probe data records to determine an anomaly score for each probe data record of the set of probe data records, wherein the ML model is trained to detect a set of anomalies associated with the probe data and further assign an anomaly score to each probe data record of the set of probe data records based on the detected set of anomalies; and
determine a quality label for the probe data based on the anomaly score.

11. The system of claim 10, wherein the detected set of anomalies comprises at least one of an invalid probe, a distant probe, a parking probe, a spiked value probe, and a zero-speed value probe.

12. The system of claim 10, wherein the anomaly score is assigned based on a predefined weight assigned to each of the detected set of anomalies.

13. The system of claim 12, wherein the predefined weight is assigned based on a functional class and a region type of the road segment associated with the probe data.

14. The system of claim 10, wherein the system is caused to perform identify one or more probe data records with missing speed and heading data, wherein the missing speed and heading data is further used to assign the anomaly score.

15. The system of claim 10, wherein the ML model is categorized as a sequence-to-sequence-based ML model, and wherein the ML model corresponds to an attention-based encoder-decoder ML model.

16. A non-transitory computer-readable medium having stored thereon, computer-executable instructions that when executed by a processor of a system, causes the processor to execute operations, the operations comprising:
obtain probe data associated with a road segment, wherein the probe data comprises of a set of probe data records;
apply a machine learning (ML) model on the set of probe data records to determine an anomaly score for each probe data record of the set of probe data records, wherein the ML model is trained to detect a set of anomalies associated with the probe data and further assign an anomaly score to each probe data record of the set of probe data records based on the detected set of anomalies; and
determine a quality label for the probe data based on the anomaly score.

17. The computer-readable medium of claim 16, wherein the detected set of anomalies comprises at least one of an invalid probe, a distant probe, a parking probe, a spiked value probe, and a zero-speed value probe.

18. The computer-readable medium of claim 16, wherein the operations further comprise identifying one or more probe data records with missing speed and heading data, wherein the missing speed and heading data is further used to assign the anomaly score.

19. The computer-readable medium of claim 16, wherein the anomaly score is assigned based on a predefined weight assigned to each of the detected set of anomalies.

20. The computer-readable medium of claim 19, wherein the predefined weight is assigned based on a functional class and a region type of the road segment associated with the probe data.
